(19) United States
(12) Patent Application Publication
(10) Pub. No.: US 2010/0170616 A1
(43) Pub. Date: Jul. 8, 2010

(54) ELECTRICALLY CONDUCTIVE TAPE FOR WALLS AND CEILINGS

(75) Inventors: Daniel Boss, Lake Villa, IL (US); David McDonald, Glenview, IL (US); Terrance Z. Kaiserman, Loxahatchee, FL (US); Keith J. Margolin, West Palm Beach, FL (US); Michael Wassief, Boynton Beach, FL (US); Liang Chai, Stuart, FL (US)

Correspondence Address: Pearne & Gordon LLP, 1801 East Ninth Street, Suite 1200, Cleveland, OH, 44114-3108, US

(73) Assignee: USG INTERIORS, INC., Chicago, IL (US)

(21) Appl. No.: 12/552,499

(22) Filed: Sep. 2, 2009

Related U.S. Application Data
(60) Provisional application No. 61/093,791, filed on Sep. 3, 2008.

(51) Int. Cl. H01B 1/02; B32B 3/10; E04F 13/00

(52) U.S. Cl. 156/71; 252/500; 252/512; 252/514; 428/131; 428/172; 427/123

(57) ABSTRACT

An electrically conductive tape for walls and ceilings is provided. The tape includes a substrate configured to be applied to at least one surface including at least one surface of a wall or ceiling and at least one conductive layer applied to the substrate. The conductive layer is penetrable by at least a conductor of an electrical device to provide an electrical connection thereto. In one embodiment the conductive layer is formed from a conductive composition including an electrically conductive material therein. The conductive composition can include a conductive ink. A method of manufacturing an electrically conductive tape or film for walls and ceilings is also provided. The method includes providing a conductive composition including an electrically conductive material therein, and providing a substrate configured to be applied to at least one surface including at least one surface of a wall or ceiling. The method also includes applying the conductive composition to the substrate forming a conductive layer attached to the substrate, the conductive layer being penetrable by a conductor of an electrical device.

This application claims the priority of U.S. Provisional Application No. 61/093,791, filed Sep. 3, 2008.

### BACKGROUND OF THE INVENTION

### Field of the Invention

The present invention relates generally to the field of electrically conductive tapes for walls and ceilings, which may be used to conduct electricity, audio signals, computer data, etc on or through the walls and ceilings of a building. The electrically conductive tape may take the form of drywall face paper, drywall corner bead materials, synthetic and/or cellulosic paper, synthetic and/or cellulosic tape, synthetic and/or cellulosic wall covering, or facing materials for construction wall or ceiling panels or ceiling tiles. The electrically conductive tape preferably takes the form as joint tape, to be applied to joints of drywall or other wall and ceiling surfaces.

Electrical or signal circuits in buildings, houses and transportation equipment are typically installed with standard wiring in dedicated locations (such as behind walls and above ceilings) and are terminated in standardized receptacles or jacks (such as wall outlets), in which the appliance (or a switch) is connected to the power or signal wiring. Typically, the wiring is located behind walls and ceilings which limits access to the wiring after installation. Often, the installed electrical wiring is not in all the locations an occupant or user would like even in new commercial and residential buildings. Because the wiring and/or receptacles are difficult to relocate once the walls and ceiling of a room have been finished, the placement of electrical appliances, such as lights, is constrained by the location of the wiring and/or receptacles. Moreover, changing the layout of the electrical system is difficult using traditional wiring technology.

The power requirements of any building are categorized into high power and low power. The low power is generally direct current (DC) at a low voltage, such as 24 volts. The high power is generally alternating current (AC) at a high voltage, such as 110 volts. Generally, both high and lower power wiring is installed in a building at fixed locations terminated with receptacles. Relocating low power wiring, and especially high power wiring, may have to be done by a licensed electrician, who may have to remove portions of walls or ceilings to access the wiring and locate new wiring in the desired location. Thereafter wiring is located at the new location, but still cannot be easily changed. Such building constraints can reduce the efficient use of space for commercial facilities, such as schools, libraries, hospitals, auditoriums, gymnasiums, cafeterias and convention halls.

It is thus desirable to provide an electrically conductive tape for powering or sending signals to electrical devices, the electrically conductive tape preferably being affixed to the outside surface of a wall or ceiling (i.e., the side facing the living space), and through which tape the electrical device may be directly connected. Such electrically conductive tape provides a multitude of easily accessible connection points throughout the walls and ceilings, thereby providing flexibility in locating devices such as, but not limited to, lighting fixtures (such as low voltage LED lights), sound masking systems, speakers, computer devices, switches, keypads, security systems, building automation systems, sensors, and other electrical appliances. In particular, the electrically conductive tape applied to a wall or ceiling may be used to provide electrical power to an appliance, as “speaker wiring” through which audio signals are transmitted to speakers, or as a “bus” through which computer or other digital signals are transmitted. Further, such electrically conductive tapes may be applied by a novice or professional when installing drywall to walls or ceilings. Alternatively, the electrically conductive tape may also be applied to rewire the walls as a retrofit to older construction. An additional benefit of such electrically conductive tape is that the surface on which the substrate is attached need not be extensively modified when an electrical device is connected or removed, such as covering portions of a wall where a receptacle was removed. Generally, to the extent not limited by its intrinsic electrical properties, the electrically conductive tape may be used in place of conventional wiring on or behind walls and ceilings as desired.

### SUMMARY OF THE INVENTION

In a first aspect of the invention, an electrically conductive tape is provided for walls and ceilings. The electrically conductive tape includes a flexible substrate configured to be applied to at least one surface including at least one surface of a wall or ceiling, and at least one conductive layer applied to the substrate.

The electrically conductive layer may be connected to a power supply to provide electrical current to the tape. The electrically conductive layer may be penetrated by a conductor of an electrical device to electrically connect the tape to the device.

In one preferred embodiment, two conductive layers, for example, positive and negative, will be applied to the substrate, the positive conductive layer to be connected to the positive side of the power supply and the negative conductive layer to be connected to the negative side of the power supply. In this embodiment, each conductive layer is connected to the respective positive and negative connectors of the electrical device.

In another preferred embodiment, the flexible substrate is joint tape, such as conventional paper or fiberglass joint tape, and the conductive layer or layers are formed thereon using a conductive composition that includes an electrically conductive material, such as silver or copper. The conductive composition may preferably be a conductive ink that is sprayed or printed on the joint tape.

In a second aspect of the invention, a method of manufacturing an electrically conductive tape for walls and ceilings is provided. The method includes providing a flexible substrate (such as joint tape) adapted to be applied to at least one surface including at least one surface of a wall or ceiling, and applying a conductive composition, preferably in the form of conductive ink, to the flexible substrate to form one or more conductive layers thereon. The conductive composition may be a coating.

In a third aspect of the invention, a method of using an electrically conductive tape is provided. The method includes affixing an electrically conductive tape to at least one surface including at least one surface of a wall or ceiling, connecting a power supply or a signal source to the electrically conductive tape, and connecting an electrical device to the one or more conductive layers of the electrically conductive tape. The signal source may be an analog or digital source.

### BRIEF DESCRIPTION OF THE DRAWINGS

The features and advantages of the present invention will become more apparent from the following description of the invention taken in conjunction with the accompanying drawings, wherein like reference characters designate the same or similar parts, and wherein:

FIG. 1 shows a view of an electrically conductive tape in accordance with an example embodiment of the present invention;

FIG. 2 shows a view of a device that may be used in conjunction with the electrically conductive tape in FIG. 1 according to an example embodiment of the present invention.

FIG. 3 shows a view of electrically conductive tape positioned on a wall or ceiling surface according to an example embodiment of the present invention.

FIG. 4 shows an application of an adhesive to the electrically conductive tape and the surface of FIG. 3 in accordance with an example embodiment of the present invention.

FIG. 5 shows an application of a coating to the adhered electrically conductive tape and the surface of FIGS. 3 and 4 in accordance with an example of the present invention.

FIG. 6 shows a view of an electrically conductive tape in accordance with an example embodiment of the present invention.

### DETAILED DESCRIPTION OF THE PREFERRED EMBODIMENTS

In order to overcome some of the problems of conventional wall and ceiling wiring discussed above, an electrically conductive tape for walls and ceilings is provided. The electrically conductive tape includes a substrate configured to be applied to at least one surface including at least one surface of a wall or ceiling, such as paper or fiberglass joint tape to be applied to drywall. The electrically conductive tape further includes at least one layer (preferably two layers) of a conductive composition applied to the substrate. The conductive layer or layers are penetrable by one or more conductors of an electrical device, such as a power supply, a signal source, and/or an electrical appliance, to provide an electrical connection between the electrically conductive tape and the device.

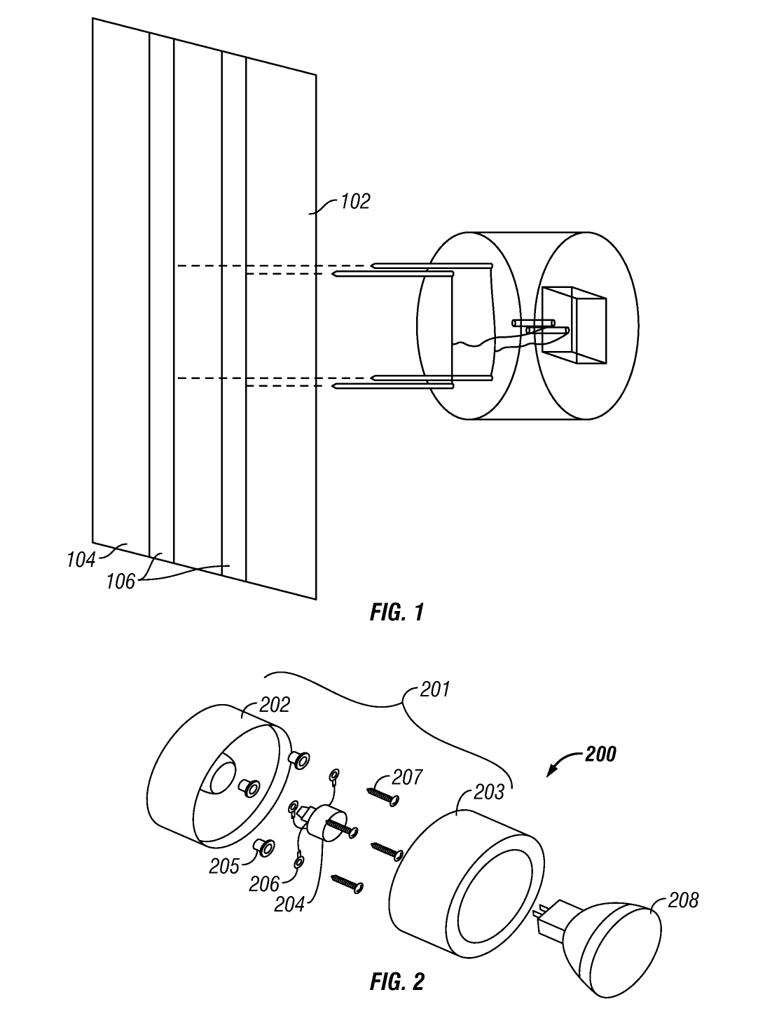

An exemplary embodiment of an electrically conductive tape in accordance with the invention is shown in FIG. 1. FIG. 1 shows electrically conductive tape 102 for walls or ceilings that includes a substrate 104 having two conductors 106, e.g., one positive and one negative, applied thereto. In a preferred embodiment, the substrate 104 is paper joint tape (such as Sheetrock® Joint Tape made by United States Gypsum Company) or self-adhesive fiberglass drywall joint tape, which is applied to standard drywall using joint or spackling compound (such as Sheetrock® All Purpose Joint Compound made by United States Gypsum Company) in a conventional manner. The electrically conductive tape 102, including the substrate 104 and the conductive layer 106, is typically flexible, but may be relatively rigid, such as joint tape conventionally used for corner joints. Further, the electrically conductive tape 102 may be applied to other wall surfaces, such as paneling and plaster.

The paper or fiberglass substrate 104 of the electrically conductive tape 102 must be suitable for receiving a thin layer of the applied conductive composition. The substrate 104 may be that of conventional joint tape, and preferably, is made of a substantially nonabsorbent material, such as polyester, polyimide (Kapton from Dupont) fiberglass, or the like. The substrate of the electrically conductive tape may alternatively contain paper, synthetic glass/polymer epoxy, polyester, MYLAR® (E.I. DuPont), polyethylene, polypropylene, acrylic, polyurethane, polyvinyl, silicone, polyamide, biopolymer or any thermoplastic blends.

The conductive layer 106 is formed from a conductive composition including an electrically conductive material therein. In one embodiment the conductive composition is comprised of a conductive ink. Such conductive compositions may be applied to the substrate by conventional spraying, laminating or printing methods. Preferably, the conductive ink consists of silver or copper (5%-85%) but may alternatively comprise any other conductive material, preferably ones that conduct low voltage power or signals. In particular, the conductive ink may instead comprise beryllium copper, zinc, stainless steel, aluminum, brass, phosphor bronze, nickel tin, lead, bismuth, gold plating or combination of these materials. Other choices of conductive materials include polymers and carbon fibers. The form of the conductive materials may be, but is not limited to, printed conductive ink, metal foils, strips, wires, screen, fibers, mesh, and non-woven materials.

If a substantially nonabsorbent material is used for the substrate 104, a cold weld process takes place, whereby the conductive particles of non-precious or precious metals form together and coalesce as a conductive layer.

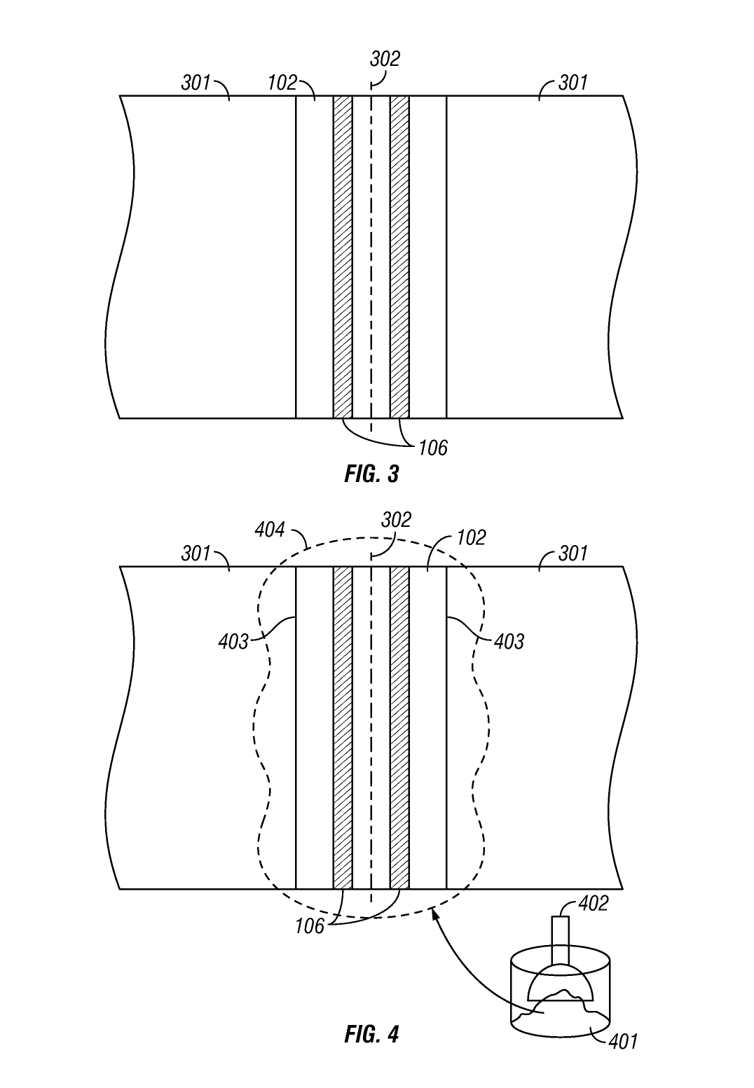

The electrically conductive tape can be applied to any wall or ceiling surface. In one example, as shown in FIGS. 3-5, the electrically conductive tape 102 is applied to a wall, by embedding it in an adhesive material, such as drywall joint or spackling compound. As shown in FIG. 3, the electrically conductive tape 102 can be positioned over a joint 302 between sheets of drywall 301. In FIG. 3, each of the two conductive layers 106 is shown preferably straddling the joint 302. When applying the electrically conductive tape to the surface, it is preferable that at least one portion of the electrically conductive tape be left exposed for attachment to a connector, such as at an end of the tape near the ceiling or floor, in order to attach a power supply to the conductive layers of the tape. The positive and negative sides of the power supply are respectively connected to each of the conductive layers of the electrically conductive tape at the exposed end to provide a voltage drop (preferably a low voltage drop) across the conductive layers. As discussed in more detail below, the positive and negative conductors of an electrical device are attached across the conductive layers to power the electrical device, or to supply it with analog or digital signals, as the case may be. Openings may be positioned or created within a conductive layer, to provide a location for switches.

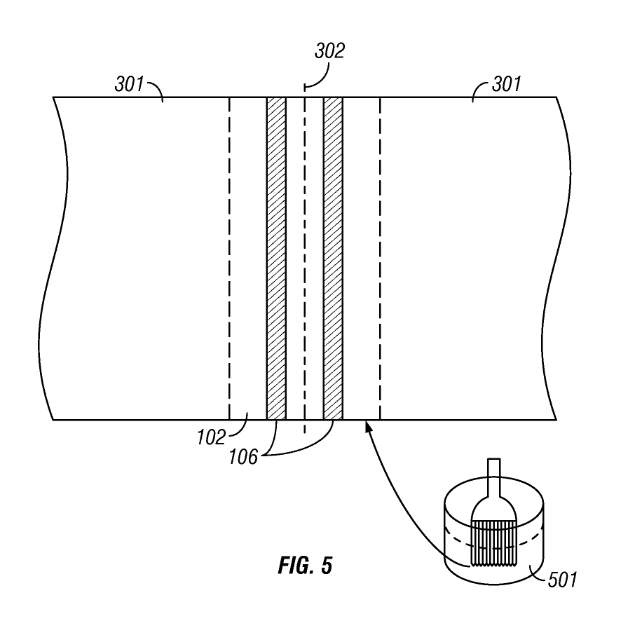

Typically, a layer of joint compound 401 is applied in and around the joint 302 with a spackling/taping knife or blade 402, and the electrically conductive tape 102 is embedded therein, wherein additional joint compound 401 may be applied over the tape 102. With the electrically conductive tape 102 positioned over the drywall 301, adhesive (e.g., joint compound) 401 may be applied over the tape 102, such as with a spackling/taping knife or blade 402, trowel, and the like, as shown in FIG. 4. The adhesive 401 is spread so as to overlap the edges 403 of the electrically conductive tape 102, as shown by the free-formed dotted lines 404. The substrate 104 of the electrically conductive tape 102 may include apertures (not shown) formed therein and through which the joint compound may pass (which is typical for conventional self-adhesive fiberglass tape). When the electrically conductive tape 102 is adhered, such as when the adhesive 401 is dry, the excess adhesive 401 may be removed or sanded to create a substantially smooth surface over the area of the electrically conductive tape 102 and at the boundary of the edge 404 of the electrically conductive tape 102 with the wall 301. As shown in FIG. 5, with the electrically conductive tape 102 attached to the wall surface 301, the wall and the area over the tape may be coated over with paint 501, wall paper, laminate, or other surfaces.

The electrically conductive tape 102 may only have a single conductive layer 106 with or without a dielectric that is used with the conductive layers of other electrically conductive tapes. Alternatively, 2 conductive layers 106 printed side by side with a dielectric space between in a horizontal fashion may be applied to the substrate of the electrically conductive tape. Also, 2 conductive layers 106 layered in a vertical fashion with dielectric layers in between each conductive layer 106 may be applied to the substrate 104. Moreover, three conductive layers, including a positive, negative, and ground, either in a horizontal fashion with dielectric in between each conductive layer 106, or in a vertical fashion with dielectric layers in between each conductive layer 106, may be applied to the substrate 104. Further, conductive layers 106 may be applied on both sides of the substrate 104 and the conductive layers on one side may be separated by a dielectric space from conductive layers on the other side.

Instead of a power supply, a digital signal generator or transmitter (such as the output side of a computer or digital communication system) may be electrically connected to one part of the electrically conductive tape 102, to be used with a corresponding digital data receiver or the like electrically connected to another part of the electrically conductive tape 102. Similarly, an analog signal generator (or speaker driver) may be electrically connected to one part of the electrically conductive tape 102, to be used with an audio receiver (or a speaker) connected at another part of the electrically conductive tape 102. Different conductive layers 106 may be used for left and right audio channels.

Similarly, a plurality of conductive layers 106 may be applied to a substrate 104. By virtue of such an arrangement each conductive layer 106 can conduct a separate electrical signal, such as in a multiconductor cable or computer bus. As such, a multiconductor conductive tape 102 can be used in place of multiconductor cables routed on or through walls and ceilings, such as telephone, cable television, and computer cabling (Ethernet, T-1, RS-232, or the like).

It is to be understood that in other embodiments the electrically conductive tape 102 may be attached to a wall or ceiling surface without adhesive and without being embedded in an adhesive material. For example, in one embodiment the electrically conductive tape 102 may be applied to a wall or ceiling surface with mechanical fasteners through the substrate 104 and/or the conductive layer 106. Moreover, a backing surface of the electrically conductive tape 102 may consist of an adhesive layer finished with a paper backing which can be peeled away to expose the adhesive during application of the electrically conductive tape 102 to a wall or ceiling surface.

Some applications where it may be useful to apply the electrically conductive tape 102 with fasteners or an adhesive backing include those where embedding or otherwise concealing portions of the conductive tape are either more difficult or of less concern, such as on the walls or ceilings of an unfinished attic, basement, garage, shed, warehouse, or utility room. In such locations aesthetic concerns may be secondary to ease of application, especially in those locations where there are few finished surfaces. In such locations, structural components such as rafters, joists, studs, and furring strips can be used as surfaces to which the electrically conductive tape 102 can be applied.

The electrically conductive tape 102 may be positioned vertically on a wall, to electrically connect the wall and ceiling together, or horizontally on a wall, to electrically connect two or more walls together, or both vertically and horizontally.

FIG. 2 shows an embodiment of an electrical device 200 that may be electrically connected to the electrically conductive tape 102 and/or the wall or ceiling surface to which the tape is affixed. In this embodiment, a lighting fixture 200 is shown having a housing 201 having a first 202 and a second 203 part. The housing houses a lamp socket 204 and includes wiring terminals 205 that can be connected to the lamp socket 204 by wiring 206 connected to the lamp socket 204. The wires 206 can be electrically connected to the housing terminals 205 of the first part with fasteners, such as screws 207, which may also be configured to pass through the terminals 205 to physically connect the housing 201 to a surface (not shown). Where screws 207 are used as fasteners, preferably screws 207 having coarse threads are used. The light fixture 200 can be electrically connected to the electrically conductive tape 102 (shown in FIG. 1) that has been applied to the surface (and mechanically connected to the surface the tape is attached to) by positioning the attachment holes (and terminals) of the first part of the housing over a corresponding conductor of the electrically conductive tape, as is shown in FIG. 1, and fastening the terminal of the lamp socket wire 206 to the terminal of the housing 205 with electrically conductive fasteners 207, such as metal screws. The fasteners 207 are configured to be of sufficient length to pass through the conductive layers 106 of the conductive tape 102 (FIG. 1). The screws 207 are configured to pierce the surface of the wall or ceiling and the conductive layer 106 beneath to electrically connect the conductive layer to the lamp socket 204. The second half 203 of the housing 201 can be attached to the first half 202 of the housing and a lamp 208 can be attached to the socket 204. The lamp 208 can be illuminated by applying a suitable voltage, such as a low voltage (i.e., 12V) across the conductors 106 of the tape 102, and may also use an internal switch to turn the lamp 208 on and off.

In other embodiments, devices are electrically connected to the conductive layers 106 by simply pushing pin shaped terminals of the device through the conductive layers and/or the wall or ceiling surface, such as is shown schematically in FIG. 1. The electrical and mechanical connections can be accomplished by different connectors. Of course devices other than lighting fixtures may be connected to the electrically conductive tape 102 and the description of the use of the electrically conductive tape 102 with the foregoing embodiments is not meant to limit the application of the tape to power distribution, but also for the distribution of digital and analog signals conventionally routed along walls and ceilings. Other electrical devices which may be electrically connected to the electrically conductive tape 102 applied to a ceiling or wall include, but are not limited, antennas, fans, cameras, sensors, and switches.

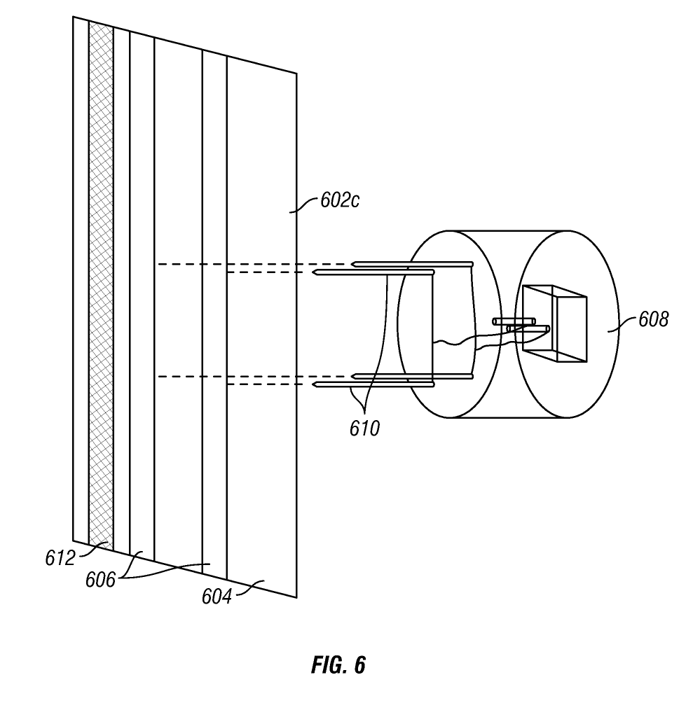

FIG. 6 shows another embodiment of an electrically conductive tape 602 like the electrically conductive tape 102 shown in FIG. 1. When the electrically conductive tape 602 is attached to the wall or ceiling as shown in FIG. 5 and is covered over with a coating such as paint or wallpaper, it becomes difficult to locate the position of the individual conductive layers 606 of the tape 602. A magnetic locator strip 612 applied to the tape substrate 604 can used to locate the position of such covered conductive layers 604 of the tape 602. The magnetic locator strip 612 may be positioned adjacent to one of the conductive layers 606, for example, at a predetermined position with respect to the conductive layer 606. Tape 602 is shown in this example having two conductive layers 606 substantially parallel to each other. In this example, the magnetic locator strip 612 extends parallel to one of the conductive layers 606, but it may instead be positioned in between the two conductive layers (not shown), or multiple locator strips may be used (not shown). Further, the magnetic locator strip 612 need not run the length of the adjacent conductor layers. The magnetic locator strip may be made of well known magnetic materials, which are applied to the substrate 604 in similar fashion as the conductive materials are applied to the substrate 604. The magnetic locator strip may itself be a magnet or may be made of a material which is attractive to a magnet. For example, in one embodiment the magnetic locator strip is made from applied iron filings.

In a case where the magnetic locator strip 612 includes materials that are attractive to a magnet, a magnet or other object behaving like a magnet placed near the magnetic locator strip 612 will be attracted thereto. Such a magnet may also include a template or guide which, when aligned with the magnetic strip 612, will identify the locations of the conductive layers 606 relative to the magnetic strip 612. In an alternative embodiment, a magnetic object (not shown) may be integrated into an electrical device 608, so that the device may be later aligned with the magnetic locator strip 612 upon installation, and hence, aligned with the conductive layers 606. In particular, when the magnetic object is sufficiently near the magnetic strip 612, it will be attracted thereto and align along the magnetic strip 612, thereby also aligning the terminals 610 of the device 608 with the conductive layers 606 of the electrically conductive tape 602. When the contacts 610 pierce through the coating and the tape 602 they will physically and electrically contact the conductive layers 606 of the electrically conductive tape 602. Of course, in a case where the magnetic strip 612 is magnetized, an object that is attractive to the magnet can be used to locate the magnetic locator strip 612 and therefore the conductive layers 606. Such an object that is attractive to such a magnetic locator strip 612 may likewise by integrated into a device that is configured to electrically connect to the conductive layers 606.

Various other embodiments and uses of the invention are possible. For example, a receptacle may be attached to the electrically conductive tape 102, such as a power outlet, modular telephone outlet, cable television or antenna outlet, or Ethernet cable outlet. In such embodiments, conductors 106 of suitable number and construction are applied to the substrate 104 to route the appropriate signals to the respective outlets.

In another embodiment, a device may be attached to the conductive layers 106 of the electrically conductive tape 102 by inserting terminals or pins of the device from an opposite side of the surface than that to which the electrically conductive tape 102 was applied. For example, the electrically conductive tape 102 may be applied to various locations on the exterior side of a wall or ceiling (that is, on the side facing away from the living space). The electrically conductive tape 102 may be applied to the drywall during its manufacture or during construction of the occupancy. Further, the electrically conductive tape 102 may be installed on the exterior side of the wall or ceiling to avoid having any unevenness to the interior side of the wall at locations other than the drywall joints. The conductive layers 106 on the electrically conductive tape 102 applied to the exterior side of the wall or ceiling can be connected to terminals of a device on the interior side of the wall by using suitable wall anchors inserted through the wall from inside the occupancy at a location of the conductor so as to pierce and contact the conductor 106. Suitable fasteners which may be useful for this purpose include toggle bolt anchors having deployable metallic tabs which can spread along the conductors while physically bringing the device into contact with the wall surface on the interior side.

Conductive compositions, such as conductive inks can be printed through various techniques such as offset lithography, letterpress, gravure, flexography, screen printing, rotary screen printing, and the like to obtain very thin conductors. Simple single layer conductors as well as multilayer conductors can be achieved using the offset or letter press process. The substrate 104 on which the conductive compositions is printed, are fed into an associated printing press by one or more sheets at a time, or as part of a continuous web where a roller feed mechanism is employed.

Various existing offset ink formulations and other coating compositions that are modified to be conductive can be used. For example, ultraviolet (UV) cured offset inks and other types of chemistry, depending upon the substrate 104 being printed and the desired properties, can be used. Most any ink or other printable composition, modified to be printed via an offset press, letter press, gravure, flexo and/or coaters can be used regardless of chemistry. The preferred embodiment is UV cured inks because they can be cured immediately after the conductive ink is applied, thus eliminating picking by the next blanket or offsetting onto the sheet stacked directly on top of the printed substrate. Existing sheet fed and web presses can be employed and the limitation to the width or length of the substrate 104 is that of the machinery it is printed on.

The materials used for substrate 104 can range from paper to various plastics and synthetics as well as laminates of various kinds. The substrate 104 may have a pressure sensitive layer thus allowing it to be mounted onto surfaces of walls and ceilings. A substrate 104 is chosen dependent upon the end properties desired. These properties include, but are not limited to, flexibility, durability, flame retardancy, coefficient of thermal expansion, moisture absorption, thickness, shape, etc. The substrate 104 can be cut from individual sheets or can be cut from a continuous web that is arranged on a roll for continuous printing. The substrate 104 may comprise, but is not limited to, paper, plastics, laminates, non woven textiles, woven and knit textiles, other polymer types or any combination determined to be necessary to achieve ultimate properties. The substrate 104 can be arranged in a single layer or multiple layers. If paper or plastic is used as a substrate 104, regardless of thickness or size, it may need a dielectric layer printed or coated on the paper to keep moisture, static and/or other unwanted elements from penetrating into the conductive inks used. This coating may also be used to enhance adhesion characteristics of any subsequent inks or coatings applied.

Some examples of substrate 104 include corner beads that may be paper-faced metallic, plastic, paper-faced plastic or paper (synthetic and/or cellulosic). Other examples include different types of facing materials that are used to provide aesthetic wall or ceiling surfaces to building materials and panel products for many industries such as, for example, paper, glass, synthetics, wallpapers, wallboard face paper, and combinations thereof.

Conductive inks can be applied via an offset lithography, letterpress or a combination press or a fine line pressure sensitive or heat activated adhesive, can be printed, that can act as a contact adhesive so that when a conductive foil or dry film comes in contact with the printed surface by hot or cold laminating, it would pull off the conductive dry film thus giving a continuity to the conductive lines that are formed. Either way would be effective in making conductive layers that can withstand a pre-engineered set of specification for resistance levels, adhesion characteristics, ultimate properties, size and shape, etc.

Line widths and spacing of the printed conductive compositions may vary from greater than that of traditional thick film printing to at least as fine as conductive lines obtained through a chemical etched process. Lines may also be printed many layers high, depending upon practicality and registration constraints.

Offset printing can use a variety of plates and methods of development. All existing methods can be employed and all plate types can be used. Blanket types and fountain solutions may vary from press to press, however, all existing types can be used. The type of printing equipment is not critical and most existing presses including one color presses can be used. A preferred embodiment may utilize a press with multiple printing heads. For example, an eight color offset press has been used with favorable results. The press can be fitted with UV curing lamps in between print heads. Infrared (IR) heaters can also be used in between stations or at a specific location on the press. Circulating hot air may also be used by itself or in combination with other heating methods.

Static eliminators of various types may be used to reduce or eliminate static from the substrate 104. Similarly, various treatments to the substrate 104 in order to enhance printability or performance, on or off press, may be employed. Spray powders may be used to prevent multiple substrate 104 sheets from sticking to one another.

In an embodiment where a sheet-fed press is used, production speeds of about 9,000 sheets per hour have been obtained. In an alternate embodiment where a roll-fed press is used, the substrate 104 can be a continuous web of material fed through a production machine at speeds of at least 100 feet/min and preferably between about 100 feet/min and 500 feet/min.

Inks can be of all known types and can be modified to be conductive and used with the methods disclosed herein. Inks can also be used as insulators. Inks can be used to dissipate heat, eliminate static, adjust dielectric constants and act as sensors. Inks used may be modified to increase scratch or abrasion resistance, adjust gloss levels. The inks include pigments and dyes of various types including optical brighteners, phosphorescence and thermochromic. The inclusion of pigments or coloring matter may be used for visual inspection for coverage, heat dissipation, light emissions and UV fluorescing for high speed inspection by visual means or mechanical means including camera and IR inspection.

Temperature and humidity conditions may vary but are best at standard paper printing environmental conditions.

The substrate 104, after printing, may be protected to eliminate contamination. The substrate may also be die cut by all conventional means or may be guillotine cut or slit in-line or off-line. Various conventional bindery equipment may be employed to bind portions of substrates 104 together.

With reference to FIG. 1, the substrate 104 may comprise paper having a moisture barrier layer printed thereon (not shown). The amount of print passes or coating passes for the moisture barrier is determined by the ultimate barrier properties desired. Single or multiple passes may be employed. Printed over the moisture barrier layer, is the first conductive lines. These conductive lines may be printed using various conductors including but not limited to, carbon black, graphite, precious metals, conductive non-precious metals, conductive polymers, etc. Depending upon the desired conductivity, one layer of conductive ink may be adequate. If one layer is not adequate, the same design, either using multiple offset plates of exactly the same design or running the substrate 104 back through a one color press for example multiple times, may be employed.

In most cases, each time conductive ink is applied over the same spot, the thickness of the conductive layer increases and the resistance decreases until a specified resistance plateau is reached. This plateau is determined by getting the lowest resistance from that particular conductive ink after a given number of print or coating passes. When the conductivity does not substantially change with the addition of a conductive ink layer, it is impractical to apply more of the same conductive ink. In such a situation, if it is desired to further increase conductivity (i.e., to lower resistance), another conductive ink either used alone or used in conjunction with the first ink, may be employed.

Any color ink may be used in order to identify a particular circuit or to create a desired pattern or design. Other types of printing and designs may be used for conductive decorative wall or ceiling coverings or instructional purposes, such as for the instruction of children. Wall or ceiling coverings having a conductive decorative design may be used, for example, as a decorative border or wall paper. Such conductive decorative coverings may be configured to be applied to a surface of the wall or ceiling with an adhesive such that the pattern or design remains viewable and uncovered. In one embodiment, conventional wallpaper glue is used as an adhesive for such decorative conductive coverings. Of course, to facilitate installation, such decorative conductive coverings may include a pre-applied adhesive covered with a removable paper backing to facilitate installation to the wall or ceiling surface. Also, such conductive decorative coverings may be configured to be attached to a surface by mechanical fasteners such as, for example, hooks, nails, and screws.

Where the substrate 104 is in sheet form, as opposed to a continuous roll, the sheets may be die cut or slit on press or off. Multiple copies of the same design can be printed on one sheet, and would then need to be separated. For example, if a printed conductive layer design encompasses 1 square inch, approximately 950 designs can be printed on a 25 inch by 38 inch sheet. Such conductive layers printed on substrates can be joined together by placing the conductive layers of each in contact with each other. This may be accomplished, for example, by overlapping two ends of strips of pressure sensitive, adhesive-backed conductive tape so that the conductive layers align and are placed in electrical contact with each other by application of adhesive force of the tape. Sheets may be designed to include numerous printed conductive layer designs to facilitate the printing of multiple orders at one time. Resistance levels may vary on different parts of the sheet by either changing conductive ink types or varying the geometry of the pattern with the same conductive inks being used.

The printing of multiple conductive layers on a single sheet reduces the non-productive times of manufacturing. These non-productive times include, set ups, wash ups, registration procedures, etc. It is better to make one set of offset plates that has two designs than two sets of plates. With two sets of plates there is additional stripping and preparation costs, additional plate charges and twice the non productive time on the press. This increases the cost on a linear basis to double versus one set of charges.

The substrate 104 may be a natural or synthetic plastic or rubber that does not require a moisture barrier layer. It may or may not need a primer coat to enhance adhesion of the inks to the substrate 104 or a corona treatment or the like to make the surface more ink receptive.

Numerous layers of conductor and resistor circuits can be printed, depending upon the design requirements. Numerous passes may be made of each and every ink being printed until the desired requirement is obtained.

In the above listed examples, the product may be finished by laminating spacers and z-axis conductors to one another to complete the fabrication of a printed circuit board. The conductive tape could be finished by having a conformal layer applied either on or off the printing press. All finishing steps can be used to utilize or protect the printed tape.

Various finishing techniques can be employed at this point including, but not limited to, die cutting, drilling, stamping and the like. Typical connectors may be attached by conventional methods.

Although the invention herein has been described with reference to particular methods and embodiments, it is to be understood that these methods and embodiments are merely illustrative of the principles and applications of the present invention. It is therefore to be understood that numerous modifications may be made to the described methods and embodiments and that other arrangements may be devised without departing from the spirit and scope of the present invention as defined by the following claims.

What is claimed is:

1. An electrically conductive tape for walls and ceilings comprising:
a substrate configured to be applied to at least one surface including at least one surface of a wall or ceiling; and
at least one conductive layer applied to the substrate, wherein the conductive layer is penetrable by a conductor of an electrical device to provide an electrical connection thereto.

2. The tape according to claim 1, wherein the conductive layer is formed from a conductive composition including an electrically conductive material therein.

3. The tape according to claim 2, wherein the conductive composition includes a conductive ink.

4. The tape according to claim 1, wherein the conductive ink includes at least one of silver and copper.

5. The tape according to claim 1, wherein the substrate is configured to be applied to the surface with an adhesive.

6. The tape according to claim 5, wherein the adhesive coating includes at least one of a mastic, glue, tar, sealant, joint compound, and spackling compound.

7. The tape according to claim 1, wherein the substrate is drywall tape.

8. The tape according to claim 1, wherein the substrate is formed having a plurality of apertures formed therein.

9. The tape according to claim 1, further comprising a magnetic strip located in a predetermined position relative to the conductive layer.

10. The tape according to claim 1, wherein the substrate is configured to be applied to the surface of a wall or ceiling with joint compound.

11. The tape according to claim 1, wherein the substrate is configured to be applied to at least one of a planar surface of a wall or ceiling and a curved surface of a wall or ceiling.

12. The tape according to claim 1, wherein the electrically conductive tape is configured to be connected to a power supply or a signal source.

13. The tape according to claim 12, wherein the power supply is a low voltage power supply.

14. The tape according to claim 1, wherein the conductive layer includes a connector.

15. The tape according to claim 1, wherein the substrate is applied to surfaces including at least one of a wall, a ceiling, a beam, a joist, and a stud.

16. A method of manufacturing electrically conductive tape for walls and ceilings comprising:
providing a substrate configured to be applied to at least one surface including at least one surface of a wall or ceiling;
providing a conductive composition including an electrically conductive material therein; and
applying the conductive composition to the substrate forming a conductive layer attached to the substrate, the conductive layer being penetrable by a conductor of an electrical device.

17. The method according to claim 16, wherein said applying step includes printing.

18. The method according to claim 17, wherein printing includes at least one of: pad printing, gravure printing, rotary printing, offset lithography, dry offset printing, letter press printing, flexographic printing, screen printing, rotary screen printing, and inkjet printing.

19. A method of using electrically conductive tape for walls and ceilings comprising:
affixing an electrically conductive tape to at least one surface including at least one surface of a wall or ceiling, the tape having a substrate and one or more conductive layers applied thereto;
electrically connecting a power supply or signal source to a portion of the tape; and
electrically connecting an electrical device to another portion of the tape.

20. The method according to claim 19, wherein the affixing step uses an adhesive to affix the tape to the surface, and the adhesive includes at least one of a mastic, glue, tar, sealant, and a joint or spackling compound.

21. The method according to claim 19, wherein the tape has two or more layers, and a first layer is electrically connected to one or positive side of the power supply or signal source, and a second layer is electrically connected to another or negative side of the power supply or signal source.

22. The method according to claim 21, wherein the first layer is connected to one or positive side of the electrical device, and the second layer is connected to another or negative side of the electrical device.
